(19) United States
(12) Patent Application Publication
(10) Pub. No.: US 2014/0282874 A1
(43) Pub. Date: Sep. 18, 2014

(54) SYSTEM AND METHOD OF IDENTITY VERIFICATION IN A VIRTUAL ENVIRONMENT

(71) Applicant: Boston Light LLC, Weymouth, MA (US)

(72) Inventor: James David Bennette, Weymouth, MA (US)

(73) Assignee: Boston Light LLC, Weymouth, MA (US)

(21) Appl. No.: 14/202,600

(22) Filed: Mar. 10, 2014

Related U.S. Application Data
(60) Provisional application No. 61/777,950, filed on Mar. 12, 2013.

(51) Int. Cl. H04L 29/06

(52) U.S. Cl. CPC H04L 63/08
USPC 726/3

(57) ABSTRACT

Methods, systems, and apparatus, including computer programs encoded on a computer storage medium, for identity verification in a virtual environment.

### CROSS-REFERENCE TO RELATED APPLICATIONS

This application claims priority of U.S. Provisional Application Serial No. 61/777,950, filed Mar. 12, 2013. The contents of the prior application are incorporated herein by reference in its entirety.

### BACKGROUND

This specification relates to a system and method of providing security to a virtual environment. More specifically this specification describes technologies relating to a system and method for providing identity verification using real time real world interaction that is fully integrated in a virtual environment.

### SUMMARY

This specification describes technologies relating to a system and method of identity verification in a virtual environment.

In general, one innovative aspect of the subject matter described in this specification can be embodied in methods that include the actions of providing virtual environment, assigning a unique user identification and profile, providing limited or restricted access to or participation to the virtual environment for the user identification or profile, initiating one or more queries or challenges to the user identity or profile that verify the real world identity of the actual user in real time, and upon successful verification of identity removing the restrictions or limitation to the virtual world for the user identity or profile. In other embodiments, the query is initiated by a virtual environment administer. In another embodiment the query is initiated by two or more virtual environment administrators. In still a further environment the query is initiated by video interaction, voice or audio interaction, text or instant massage interaction, or a combination thereof, wherein the query is initiated in the virtual environment and answers are provided in real time by the actual user of the user profile, wherein such answers provide verification of the real world identity in real time of the user of the identity or profile in the virtual world. Additional embodiments of these aspects include corresponding systems, apparatus, and computer programs, configured to perform the actions of the methods, encoded on computer storage devices.

These and other embodiments can each optionally include one or more of the following features. In one example embodiment a method performed by data processing apparatus is provided, the method comprises the steps of: providing a virtual environment, assigning a unique user identification and profile, providing limited or restricted access to or participation to the virtual environment for the user identification or profile, initiating one or more queries or challenges to the user identity or profile that verify the real world identity of the actual user in real time, and upon successful verification of identity removing the restrictions or limitation to the virtual world for the user identity or profile.

In yet another example embodiment, a computer storage medium is provided wherein the storage medium is encoded with a computer program, the program comprising instructions that when executed by data processing apparatus cause the data processing apparatus to perform operations comprising: accepting a request to create a unique avatar for a specific user; providing limited or restricted access to or participation to the virtual environment for the user identification or profile, initiating one or more queries or challenges to the user identity or profile that verify the real world identity of the actual user in real time, and upon successful verification of identity removing the restrictions or limitation to the virtual world for the user identity or profile.

Particular embodiments of the subject matter described in this specification can be implemented so as to realize one or more of the following advantages. A virtual word experience is provided wherein users or administrators can verify the real world identity of a user in real time while still interacting with the avatar in the virtual environment in virtual time. A system and method are provided to maintain the safety and integrity of users and administrators in a virtual world wherein interaction between a user and administrators is accomplished simultaneously in the virtual and real world; interactions between the administrators and user are always done wherein two administrators interact with the user in both the real world and the virtual world; one administrator can interact with a user in the virtual world and a second administrator can interact with the same user in the real world; one or more administrators can monitor the interactions of two or more users in a virtual world; a first user can request a virtual world administrator to verify the identity of a second user of the virtual world; a first user can interact with a second user in a virtual world and verify the real world identity of the second user in the real world without detracting from the virtual experience. Multiple challenges to user identity can be made in a virtual environment that verifies real world identity without detracting from the virtual experience. A system can be provided that allows for textual, audio or video interaction between two real world users through a virtual environment enabled by virtual avatars.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an system diagram of an example implementation of the present invention.

FIG. 2 is a flow chart of an example method of the present invention.

FIG. 3 is a flow chart of an example method of the present invention.

FIG. 4 is a flow chart of an example method of the present invention.

FIG. 5 is a graphical depiction of an example implementation of the present invention.

FIG. 6 is a graphical depiction of an example implementation of the present invention.

FIG. 7 is a graphical depiction of an example implementation of the present invention.

FIG. 8A is a graphical depiction of an example implementation of the present invention.

FIG. 8B is a graphical depiction of an example implementation of the present invention.

FIG. 9A is a graphical depiction of an example implementation of the present invention.

FIG. 9B is a graphical depiction of an example implementation of the present invention.

FIG. 10A is a graphical depiction of an example implementation of the present invention.

FIG. 10B is a graphical depiction of an example implementation of the present invention.

### DETAILED DESCRIPTION

As shown in FIG. 1, a system 10 for providing a virtual environment over a network 15 comprising one or more servers 20 for serving and administering the network and/or virtual environment operating program. Included in the system are one or more administrator terminals 25, and one or more user terminals, including personal computer 30, laptop computer 32 (or tablet computers not shown), and mobile device 34 (including smart phones and other smart mobile devices). As described in further detail below, servers 20 provide a virtual environment over network 10 for interaction by individual users via user terminals 30, 32, and/or 34. In various implementations, a first user can log in to the virtual environment using a unique user identification and profile, creating a unique avatar or user handle. The system will provide restrictions and limitations to the access the user, wherein the avatar may not access all functions or areas of the virtual environment or may not be able to interact fully with other avatars.

The system administrator may interact with the avatar in any manner or form, including via an administrator avatar or preset features in the virtual environment. In one embodiment, the system administrator or the virtual environment operating system interacts with the first user avatar in the virtual environment. During such interaction the administrator or the virtual environment operating system initiates a challenge or queries the avatar in such a manner that the first user must provide information to verify the user's real world identity. Interactions verifying the user identity can be in a single or in multiple events. In an implementation, the identity verification is incorporated into the theme of the virtual environment so as not to detract from the virtual experience.

In another implementation, the interactions can be a series of questions asked and answered via a real time text based messaging system. In yet another implementation, the interactions can be a real time video or audio conference operating simultaneously with the virtual reality environment. In one embodiment the user experiences the virtual reality environment and the real world queries simultaneously. By such simultaneous interactions the administrator, or any other user, can verify the first user identity and confirm the person behind the avatar is actually who is registered and has met eligibility criteria to participate in the virtual environment. Once verification is complete, restrictions for the user or avatar participation in the virtual environment can be lifted.

FIG. 2 illustrates an example method of the present invention comprising: assigning a 1^{st} user profile to a virtual environment (10); creating an avatar assigned to the 1^{st} user (12); providing restricted access to the virtual environment by the avatar/1^{st} user (14); initiating one or more challenges to the avatar by one or more virtual environment administrators (16); and removing all or some of the restrictions placed on the avatar for each successful completion of the one or more challenges by the first user (18).

The virtual environment of the present invention may be any virtual reality world or experience including fantasy worlds, games, academic or training environment, historical worlds, social media systems, or a closed networked communication network. The virtual environment can be tailored to a particular organization, particularly organizations that are concerned with verifying eligibility of members, such as youth organizations, student bodies, social organizations, dating websites, social media clubs, user groups, employee groups and the like.

When a 1^{st} user logs into the virtual environment, the user must register and provide basic information to establish eligibility for participation in the virtual environment. Based on the initial registration information a user profile is assigned (10) and an avatar is created (12) for the 1^{st} user. The user profile and avatar are unique to the 1^{st} user. The 1^{st} user and the assigned avatar may only enjoy limited access to the virtual environment due to restrictions placed on the user (14) until the user's real world identity can be verified.

One or more challenges or queries can be initiated and presented to the avatar in the virtual environment (16). These challenges are designed to verify the 1^{st} user's actual real world identity and confirm the 1^{st} user's eligibility for participation in the virtual environment. The challenges or queries can be presented to the avatar by one or more virtual environment administrators. The challenges or queries can be presented to the avatar as part of the virtual environment program. The challenges can be a combination of challenges initiated by the virtual environment administrator(s) and the virtual environment program. The challenges are made to the avatar and allow the avatar to fully participate in and experience the virtual environment while simultaneously requiring the 1^{st} user to provide real time information in the real world environment. For example, the challenge may be initiated by a system administrator to the avatar in the form of a task to be completed in the virtual environment. As part of the task, the avatar may create a link to the real world to provide a video or audio conference, such as those enabled by Skype® or Facetime®, wherein the 1t user communicates directly with the administrator(s) thereby providing simultaneous real world and virtual world interaction without detracting from the virtual experience, all the while allowing for real time verification of the 1^{st} users actual identity and credentials.

In one embodiment the challenge(s) is/are initiated by two administrators to provide integrity and ensure appropriate interaction between the 1^{st} user and the administrators.

The challenges can be initiated and presented in multiple layers, levels, tasks, or experiences within the virtual environment. Upon each satisfactory completion of the challenge, the avatar and the 1^{st} user are allowed greater access to the virtual environment and the restrictions are removed (18).

Restrictions can include the ability to interact with other avatars, access to information, abilities or character attributes for the avatar such as powers, abilities, wardrobe, access to user groups or sub-groups, access to various levels, areas or micro-environments with-in the virtual world, or access to other virtual or real world environments or events.

In one embodiment, one or more administrator(s) monitor the interactions of a 1^{st} avatar with the virtual environment and/or other avatars such as a second avatar. At any time the administrator(s) can initiate a challenge to the 1^{st} avatar to confirm the 1^{st} user's identity and eligibility criteria for participation in the virtual environment and interaction with other members/users in the virtual environment. These challenges or queries can be presented to the avatar as part of the virtual environment program, thereby preserving the user experience for both the 1^{st} user and the second user. The challenge, as previously described requires the 1^{st} user to provide real world, real time information to verify identity. Such information can be provided via a video or audio link, or a textual message service.

FIG. 3 illustrates an example method of the present invention comprising: providing an interactive virtual reality (“VR”) environment (10); assigning a 1^{st} user identity or avatar unique to the VR environment (15); providing restricted or limited access and interaction by the 1^{st} user avatar to the VR environment (20); allowing limited interaction between the 1^{st} user avatar and the VR environment (22); allowing limited interaction between the 1^{st} avatar and a second user avatar (24); initiating a challenge, query, or prompt to the 1^{st} user avatar (31) where in the challenge, query, or prompt is initiated by the VR environment administrator (32) or a second user avatar 33; receiving a satisfactory answer to the challenge, query, or prompt (35, 36), and allowing unrestricted interaction between the 1^{st} user avatar and the 2^{nd} user avatar (45) and/or removing restricted access for the 1^{st} user to the VR environment (50). In another embodiment, should the second user receive an unsatisfactory answer or information to the challenge, query, or prompt the second user can block interaction with the 1^{st} user avatar (39) or transfer (37) the challenge, query, or prompt to the VR environment administrator (32) for further verification. The embodiment depicted in FIG. 3 may be used in a closed group virtual environment wherein there is a risk of unauthorized access by an intruder or predator, such as in a VR environment created for youth groups, student bodies, social, religious or social organizations, and the like. In such implementations, VR environment administrators can monitor and verify identity without detracting from the VR experience.

FIG. 4 illustrates an example method of the present invention comprising: providing an interactive social media environment (10); assigning a 1st user identity or handle unique to the social media environment (15); providing restricted or limited access and interaction by the 1st user handle to the social media environment (20); allowing limited interaction between the 1st user handle and the social media environment (22); allowing limited interaction between the 1st user handle and a second user (24); initiating a challenge, query, or prompt to the 1st user handle (31) wherein the challenge, query, or prompt is initiated by the social media environment administrator (32) or a second user 33; receiving a satisfactory answer to the challenge, query, or prompt (35, 36), and allowing unrestricted interaction between the 1st user and the 2nd user (45) and/or removing restricted access for the 1st user to the social media environment (50). In another embodiment, should the second user receive an unsatisfactory answer or information to the challenge, query, or prompt the second user can block interaction with the 1st user (39) or transfer (37) the challenge, query, or prompt to the social media environment administrator (32) for further verification. The embodiment exemplified in FIG. 4 can be used in connection with a social media network, a dating or introduction network, and entertainment network, a user group and the like. Such embodiment allows for a second user to verify the identity of a first user in real time or to allow a system administrator to verify the identity of a first user in real time, without detracting from the virtual experience of either the first or second users.

FIGS. 5-10B illustrate an example embodiment of the present invention wherein the system and method of the present invention are implemented as part of a VR environment for a youth organization concerned with unauthorized adults interacting via an avatar with youth members of the VR environment. The present example can be modified to include multiple levels of interactivity to accommodate as many challenges to the avatar as is needed to verify or re-verify an avatar's real world identity. For each successfully completed challenge the user can be drawn further into the virtual reality experience by gaining access to previously closed or restricted functions or areas within the virtual world. In the example, two system administrators participate in each challenge to ensure integrity and safety of all users and administrators.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network.

The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
providing a virtual environment,
assigning a unique user identification and profile,
providing limited or restricted access to or participation to the virtual environment for the user identification or profile,
initiating one or more queries or challenges to the user identity or profile that verify the real world identity of the actual user in real time, and
upon successful verification of identity removing the restrictions or limitation to the virtual world for the user identity or profile.

2. A computer storage medium encoded with a computer program, the program comprising instructions that when executed by data processing apparatus cause the data processing apparatus to perform operations comprising:
accepting a request to create a unique avatar for a specific user;
providing limited or restricted access to or participation to the virtual environment for the user identification or profile,
initiating one or more queries or challenges to the user identity or profile that verify the real world identity of the actual user in real time, and
upon successful verification of identity removing the restrictions or limitation to the virtual world for the user identity or profile.
